(19) United States
(12) Patent Application Publication
(10) Pub. No.: US 2026/0368197 A1
(43) Pub. Date: Nov. 19, 2026

(54) METHODS AND SYSTEMS FOR PIPELINE CREATION AND DATA TRANSFORMATION

(71) Applicant: JPMorgan Chase Bank, N.A., New York, NY (US)

(72) Inventors: Kiran Pamidimarry, Glasgow (GB); Sushant Vijaydatta Zanjure, Glasgow (GB); Siva Bangaru, Glasgow (GB); Malcolm McNeill, Glasgow (GB)

(73) Assignee: JPMorgan Chase Bank, N.A., New York, NY (US)

(21) Appl. No.: 19/209,275

(22) Filed: May 15, 2025

(51) Int. Cl. G06F 16/25; G06F 11/34; G06N 3/0475

(52) U.S. Cl. CPC G06F 16/254; G06F 11/3409; G06N 3/0475

(57) ABSTRACT

There are provided systems and methods for pipeline creation and data transformation in data processing architectures. For example, a system is provided. The system includes a processor and a memory storing instructions that, when executed by the processor, cause the system to perform various operations associated with the orchestration, transformation, and deployment of a data pipeline. The system includes a repository configured to store metadata associated with the data pipeline, wherein the metadata comprises information relating to source datasets, destination datasets, transformation sequences, and processing dependencies.

### TECHNICAL FIELD

The present disclosure relates to methods and systems for creating pipelines and for transforming data in data processing architectures.

### BACKGROUND

In modern data processing architectures, pipeline creation and transformation logic for each pipeline is often hardcoded, leading to challenges in scalability, maintainability, and governance. Conventional approaches require extensive manual efforts to modify transformation logic, verify consistency, and deploy changes across multiple pipelines.

### SUMMARY

Given the aforementioned deficiencies, a need exists for a framework that centralizes transformation logic, enabling seamless pipeline configuration, transformation management, automated approval workflows, and deployment to a cloud environment.

The embodiments featured herein help solve or mitigate the above noted deficiencies as well as other issues known in the art. For example, in an exemplary embodiment, a system is provided comprising a processor and a memory comprising instructions which, when executed by the processor, cause the processor to perform operations for enabling the configuration, transformation, and deployment of a data pipeline.

The disclosure provides a metadata-driven framework, also referred to herein as MetaFlow. This framework centralizes transformation logic, enabling seamless pipeline configuration, transformation management, automated approval workflows, and deployment within a cloud environment such as Amazon Web Services (AWS). This framework also creates data pipelines dynamically based on pre-configured metadata settings. It centralizes transformation logic to be applied across multiple data pipelines and supports user-interface (UI) based transformation management with a maker-checker approval process to validate modifications before deployment. Additionally, the framework automates deployment of transformation logic into a cloud infrastructure (e.g., AWS) and ensures data lineage tracking, enhancing transparency and governance.

Under certain circumstances, an embodiment of the present disclosure provides a system configured to store metadata associated with the data pipeline. A transformation logic engine is provided and configured to apply a transformation rule to a dataset of the data pipeline based on the stored metadata. The system further comprises a graphical user interface (GUI) configured to enable a user to manage an approval process based on the transformation logic performed by the transformation logic engine. Additionally, the system includes an automated deployment engine configured to deploy the data pipeline in a cloud environment.

The system of any preceding clause, wherein the automated deployment engine is configured to deploy the data pipeline subsequent to the transformation rule having been applied to the dataset.

The system of any preceding clause, further including a lineage tracking module configured to maintain a record of the transformation rule having been applied to the dataset.

The system of any preceding clause, wherein the transformation logic engine dynamically generates pipeline execution scripts.

The system of any preceding clause, wherein the metadata includes information about source datasets, destination datasets, transformation sequences, and processing dependencies.

The system of any preceding clause, wherein the GUI includes audit logging features.

The system of any preceding clause, wherein the system further includes a metrics dashboard for pipeline performance monitoring.

The system of any preceding clause, further comprising machine learning modules configured to recommend transformation rules based on dataset patterns.

The system of any preceding clause, further comprising a generative artificial intelligence (AI) engine configured to propose transformation workflows based on high-level user goals.

The system of any preceding clause, wherein the system includes self-healing mechanisms for automatic correction of pipeline execution failures.

The system of any preceding clause, wherein a digital twin simulation engine allows for virtual testing of pipeline configurations prior to production deployment.

Another embodiment includes A computer-implemented method for transforming a data pipeline, comprising providing a repository including metadata associated with a data pipeline and providing a transformation logic engine configured to apply a transformation rule to a dataset of the data pipeline based on the metadata. The method also includes providing a GUI configured to enable a user to manage an approval process based on a transformation logic of the transformation logic engine, and providing an automated deployment engine configured to deploy the data pipeline in a cloud environment

The method of any preceding clause, wherein the operations further include automatically deploying the data pipeline subsequent to the transformation rule having been applied to the dataset.

The method of any preceding clause, wherein the operations further include maintaining a record of the transformation rule having been applied to the dataset

The method of any preceding clause, wherein the operations further include dynamically generating pipeline execution scripts.

The method of any preceding clause, wherein the operations further include monitoring a performance of the pipeline via a dashboard.

The method of any preceding clause, wherein the operations further including version controlling.

The method of any preceding clause, wherein the operations further include deploying the data pipeline to the cloud environment utilizing one a continuous delivery platform.

The method of any preceding clause, wherein the operations further include deploying the data pipeline to the cloud environment utilizing a continuous integration and continuous delivery/deployment (CI/CD) pipeline.

The method of any preceding clause, wherein the operations further include executing an approval process prior to executing the transformation rule on the dataset.

Yet another embodiment includes a non-transitory computer readable medium having stored thereon computer executable instructions that, if executed by a processor, cause the processor to perform a method comprising providing a repository including metadata associated with a data pipeline and providing a transformation logic engine configured to apply a transformation rule to a dataset of the data pipeline based on the metadata. The method also includes providing a GUI configured to enable a user to manage an approval process based on a transformation logic of the transformation logic engine, and providing an automated deployment engine configured to deploy the data pipeline in a cloud environment.

Additional features, modes of operation, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1A illustrates a system constructed and arranged in accordance with an embodiment of the present disclosure.

FIG. 1B illustrates a view of a system constructed and arranged in accordance with an embodiment of the present disclosure.

FIG. 1C illustrates a view of a system constructed and arranged in accordance with an embodiment of the present disclosure.

FIG. 2 illustrates a workflow of an exemplary use case according to an embodiment of the present disclosure.

FIG. 3 illustrates an exemplary method according to the embodiments.

FIG. 4 illustrates an exemplary computer architecture upon which embodiments of the present disclosure may be practiced.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

The embodiments of the disclosure provide several advantages over the state-of-the-art. For instance, the embodiments provide methods and systems for dynamic pipeline configuration and execution. In the embodiments, a pipeline may be configured using declarative metadata. Furthermore, in the embodiments, a pipeline may be configured using the declarative metadata that specifies a plurality of attributes and/or a plurality of directives.

For example, and not by limitation, the declarative metadata may include source and destination datasets and transformations to be applied. They may include processing rules and dependencies. Moreover, in the embodiment, there may be provided a technological infrastructure in the form of hardware, software, or firmware, or a combination thereof to automatically generate and execute pipelines based on configurations included in the declarative metadata.

In one exemplary embodiment, a system may include a central repository where transformation rules are stored as metadata. The system may be configured to maintain this repository. The metadata may define pipeline attributes, transformation logic for one or more datasets in the repository, as well as a predetermined execution sequence. When a pipeline is executed by system, the metadata repository dynamically applies the appropriate transformations without requiring manual code updates.

One exemplary embodiment includes a UI-driven management process. The process may include a maker-checker module that includes a GUI for transformation management. The GUI may enable creation, modification, and deletion of transformation rules. Furthermore, the maker-checker module may include an approval process to validate changes of audit logs for ensuring proper governance and compliance.

In yet another exemplary embodiment, there may be provided a system for automated deployment and cloud integration. In the exemplary embodiment, upon approval, transformations are automatically deployed into a cloud computing platform, using a CI/CD pipeline. AWS is one example of such a cloud computing platform. This process ensures that changes are applied in real-time without downtime and that the transformation logic remains consistent across all environments. Furthermore, the embodiment preserves data lineage and auditability by tracking all transformations applied to datasets, providing a clear lineage trail. This feature enhances regulatory compliance, as well as debugging and troubleshooting for data integrity validation.

An embodiment of the present disclosure can include a system designed to streamline data transformation and pipeline execution. The exemplary system can include a plurality of components, including at least one selected from the list of components including a metadata configuration engine, a transformation logic repository, a web-based user interface with built-in transformation management and approval engine, a CI/CD deployment pipeline, a monitoring engine, and a self-healing engine. These components may work individually or together to provide a scalable, automated solution for managing complex data workflows in cloud environments.

The embodiments feature a metadata-driven approach that defines source and destination datasets, transformation logic, and dependencies. Based on this configuration, an exemplary system may dynamically generate and execute pipeline scripts or jobs. For example, and not by limitation, execution may be performed in a cloud-based environment. Further, an exemplary embodiment in the cloud-based environment may include supporting technology modules configured to ensure high-performance and scalable data process. Such supporting technologies may be, for example and not by limitation, Apache Spark or Delta Lake.

The embodiments may include a central repository that houses reusable transformation templates and logic for individual datasets. The repository may allow for efficient management and reusability of transformation components. The repository may include version control infrastructure. For example, all changes to the logic may be archived and version controlled. In such an embodiment, changes may go through an approval process before they are deployed, ensuring consistency and auditability. Furthermore, during runtime, the execution engine may pull information from the repository to dynamically apply the appropriate transformations as defined in the metadata.

Further, the embodiments may include a graphical user interface for managing metadata configurations and transformation rules supporting a maker-checker workflow. For example, and not by limitation, the interface may be configured to allow one user (the maker) to create or modify rules, and it may allow another (the checker) to approve them prior to deployment. With this feature, an exemplary embodiment may be configured to ensure a robust control mechanism wherein all actions are logged in an audit trail to maintain compliance requirements. Furthermore, it shall be construed, without limitation, that a user (maker or checker) may include either another system, a system with one or more humans-in-the-loop, or human users.

Furthermore, the embodiments may be configured to integrate infrastructure-as-code tools. As one example, an infrastructure-as-code tool may be Terraform. Moreover, the embodiments may be configured to integrate continuous delivery platforms. For example, and not by limitation, a continuous delivery platform may be Spinnaker. With either an infrastructure-as-code tool or a continuous deliver platform, or with both, the embodiments may be configured to automate the deployment of transformations.

The deployment process may be designed to support zero-downtime updates and to allow for configuration adjustments based on specific environments. For example, and not by limitation, an embodiment as described above may be executed on a cloud computing platform such as AWS and databricks. In this scenario, the embodiments enable efficient scaling and resource utilization in cloud-native architectures.

One or more, or all, of the transformations performed in an embodiment may be tracked by a module in real-time, providing full data lineage from source to target. This feature allows transparency in how data are manipulated and moved across systems. Furthermore, an exemplary embodiment my include one or more dashboards to allow visualizing lineage paths, trace changes over time, and to allow auditing of user access policies. These features promote strong data governance and compliance practices.

One exemplary use case has led to significant efficiency improvements over one or more aspects of state-of-the-art solutions. For example, with one embodiment, pipeline creation time has been reduced from 60 hours to just 20 hours. Furthermore, when scaled across 100 pipelines, this improvement equates to a total of 4,000 hours saved, resulting in cost savings of approximately $280,000. These gains demonstrate a substantial return on investment the present embodiments can provide. It is noted that further gains may be possible, depending on the environment and scenarios in which an exemplary embodiment is used. As such, the results noted above are merely exemplary and thus not limiting.

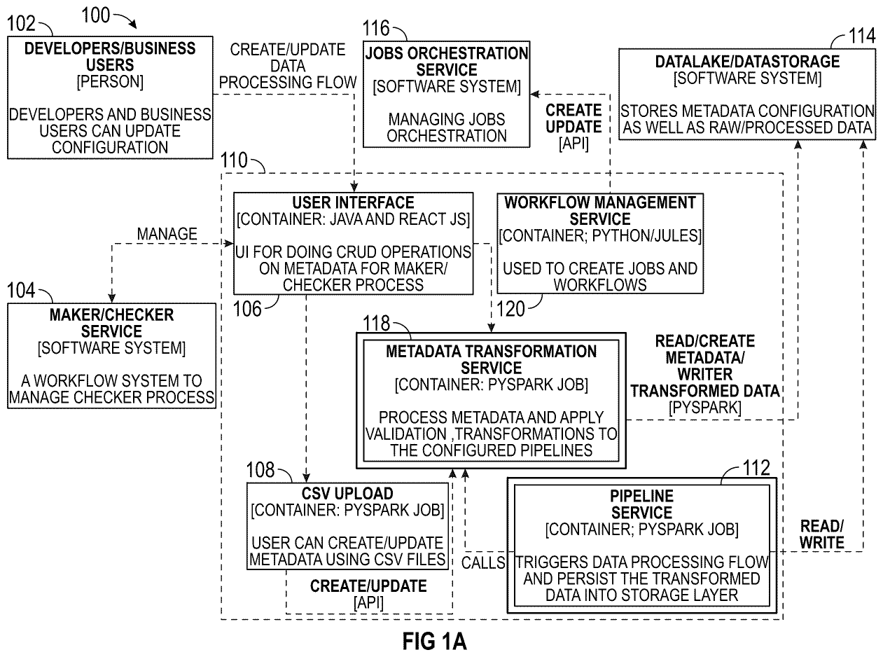

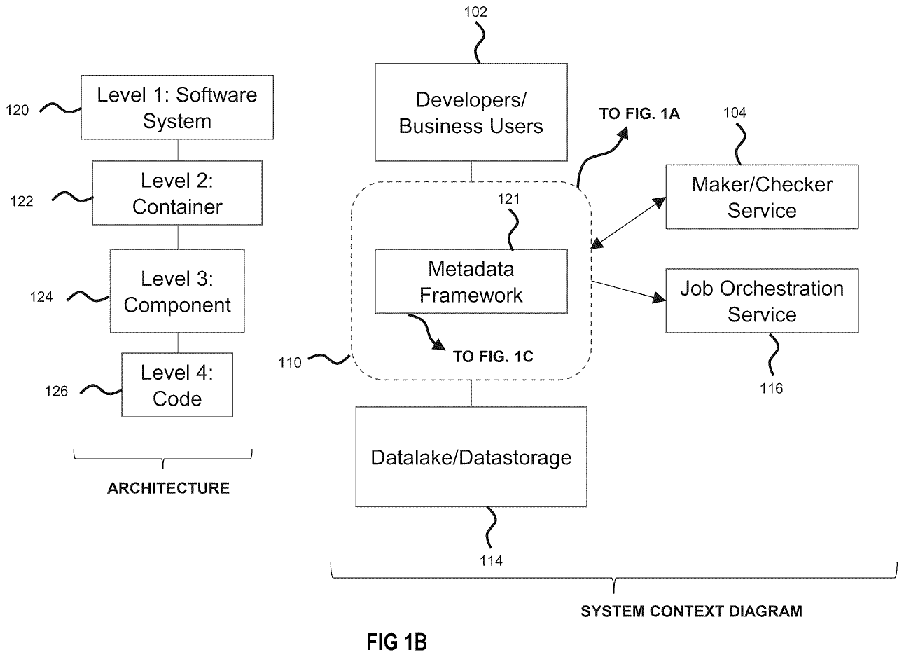

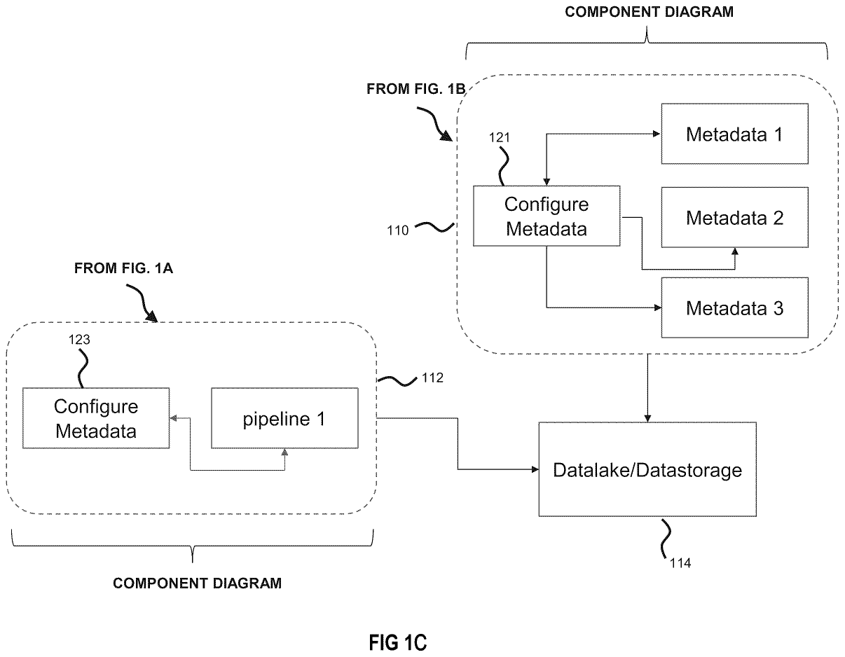

FIG. 1A illustrates a system 100 according to an embodiment. The system 100 may be an application-computer system that is structurally configured to perform the functions discussed herein to provide the advantages discussed throughout the disclosure, and in the context of pipeline creation and data transformation. The system 100 may include an input module 102 configured to provide access to the various subsystems of the system 100 included in a container module 110.

The input module 102 may be configured to allow developers or business users to update a configuration of the system 100. This may be done via a UI 106 built, for example and not by limitation, using Java and React JS. The UI 106 may be configured for create, read, update, delete (CRUD) operations on metadata for one or more maker/checker processes.

The UI 106 may be communicatively coupled to a comma-separated values (CSV) upload module 108 implemented in a Pyspark Job container. Through the CSV upload module 108, a user may create/update metadata using CSV files. It is noted that while CSV files are contemplated in this implementation, the teachings of the present disclosure are not limited to such files. Broadly, other file types known to persons of ordinary skill in the art may be used to achieve the same function as the function of the CSV upload module 108.

The CSV upload module 108 may be communicatively coupled via an application programming interface (API) to a metadata transformation service module 118 configured to create or update a metadata and apply validation, transformation to the configured pipelines.

In another data path, the UI 106 may be bidirectionally coupled to a maker/checker service module (MCSM) 104, which may run on the native software of the system 100. The MCSM 104 may be configured to manage workflows and processes.

A workflow management service of the container 110 may be configured to create or update, via an API, a job orchestration service module (JOSM) 116 configured to manage job orchestration tasks. Furthermore, a Datalake/Datastorage module (DDM) 114 may also be interface with the Metadata Transformation Service module to store metadata configuration as well as raw or processed data. The JOSM 116 and the DDM 114 may both run on the system's native software.

The container 110 may further include a pipeline service module 112 which may be configured to call the metadata transformation service module 118 to trigger data processing flows and persist the transformed data into a storage layer by writing to the DDM 114. The pipeline service module 112 may also be configured to read data from the DDM 114.

FIG. 1B shows higher level views of the organization of the system 100. They system 100 can have Software System level functions 120 (Level 1) which interact with, manage, and enable lower-level functions. Such lower-level functions maybe Container functions 122 (Level 2), which enable Component level functions 124 (Level 3), under which there are code 126 (Level 4) that can be executed by the system 100 to perform the various functions described above. Furthermore, in the system context, the container 110 of FIG. 1, at a higher level, operates as a Metadata Framework 121.

FIG. 1C shows the two example components included in the container 110, i.e., from the Metadata Framework 121. For instance, the Pipeline Service 112 in FIG. 1A, at the component level, can include a configuration module 123 that configures a pipeline 125 according to configuration metadata and transformation logic from the Metadata Framework 121; results from these operations may be outputted to and archived in the DDM 114. Similarly, at the component level, the container 110 may generally include a configuration module 121 that is configured to change metadata files, templates, and transformation logic. The metadata files, templates, and transformation logic may be outputted and archived in the DDM 114.

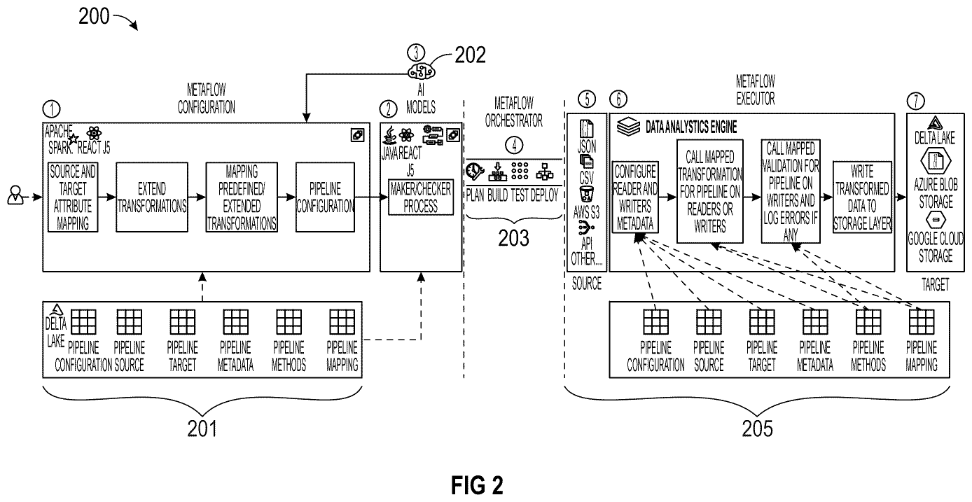

FIG. 2 illustrates an exemplary workflow 200 that may be used with the system 100. The workflow 200 may include a set of steps 201 which include:
a) setting up a data transformation pipeline including attribute mapping, transformation of an application, and pipeline configuration modules;
b) executing a maker/checker process that reviews and approves changes to ensure data integrity and accuracy before implementation; and
c) executing AI models designed to suggest intricate transformations by analyzing dataset characteristics and existing mappings.

AI models 202 are designed to suggest intricate transformation by analyzing dataset characteristics and existing mappings associated with the workflow 200.

The workflow 200 may further include a set of steps 203 that include managing the pipeline lifecycle. The pipeline lifecycle may include planning, building, testing, and deploying the pipeline to ensure readiness for production.

The workflow 200 may further include a set of steps 205 that include:
a) providing various types of sources to an executor;
b) executing the pipeline by configuring data readers/writers, applying transformations, validating data, and storing transformed data; and
c) processing the data and storing the data in one or more different clouds (e.g., Delta Lake, Azure Blob Storage, Google Cloud).

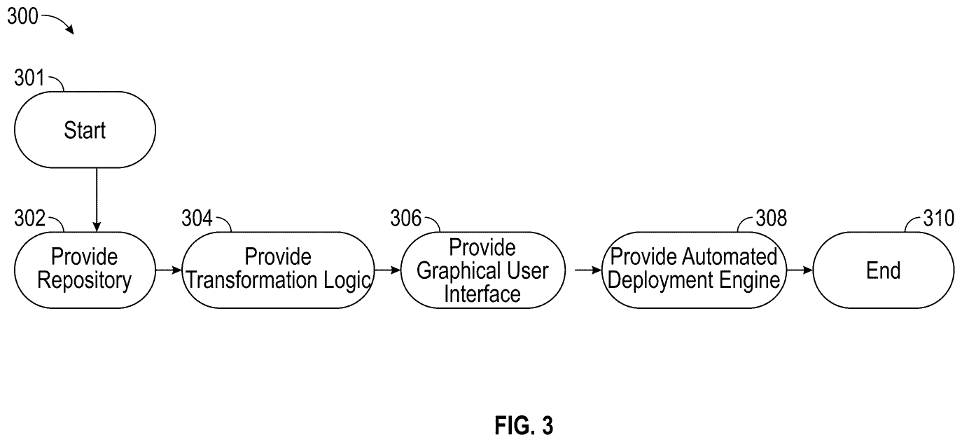

FIG. 3 describes an exemplary method 300 for data transformation and pipeline creation. The method 300 may be embodied as a set of instructions executed by the processor (described below) of a system. Such a system may be like one or more of the systems described herein. Upon executing the method 300, the system's processor may execute certain operations consistent with data transformation and pipeline creation. The operations may start at step 301, which may include initialization steps.

The method 300 may then include a step 302 which may include providing a repository. The method 300 may include a step 304 that includes providing transformation logic and a step 306 that includes providing a GUI. Further, the method 300 may include providing an automated deployment engine at a step 308, and the method 300 may end at a step 310. The steps of the method 300, as described, may include various sub-steps consistent with the various corresponding operations of the system embodiments described herein.

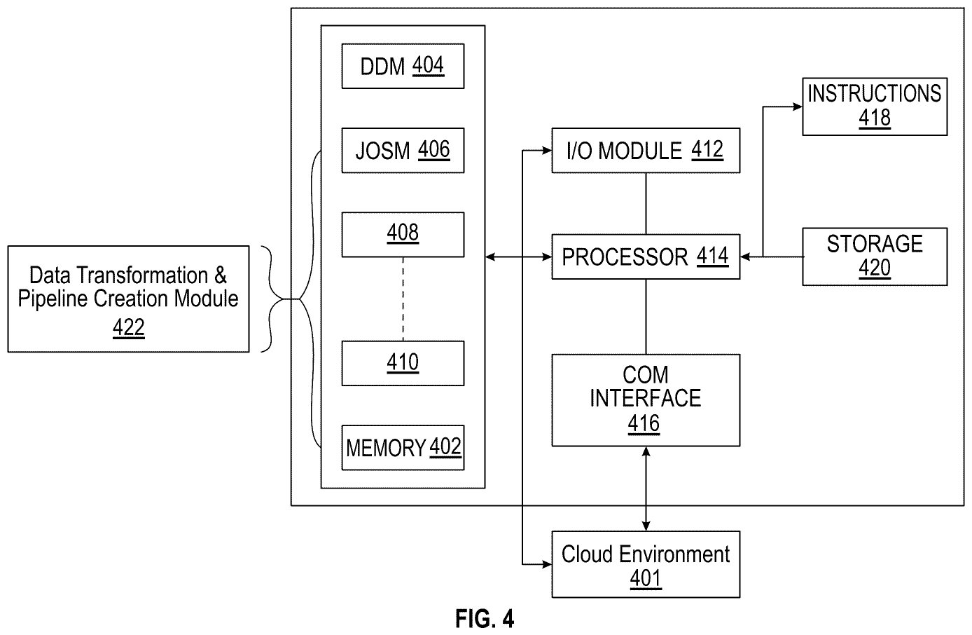

FIG. 4 describes an exemplary computer system 400 configurable to execute the various methods and processes described above. In the computer system 400, each of or all of the various methods described herein, such as the method 300 may be embodied as instructions which can cause the computer system 400 to perform operations consistent with pipeline creation and data transformation. For example, the various methods may be embodied as instructions residing in a non-transitory component such as a memory or a storage device associated with the computer system 400. That is, the structure of the system 400 is imparted by the methods described herein in the form of instructions.

The system 400 may be an application-specific hardware, software, and firmware implementation (or a combination thereof) configured to execute the exemplary methods described herein. The computer system 400 may also represent a structural and application-specific implementation of the method 300 described herein. The computer system 400 can include a processor 414 configured to execute one or more, or all of the blocks of the exemplary methods described previously.

The processor 414 can have a specific structure imparted thereto by instructions stored in a memory 402 and/or by instructions 414 fetchable by the processor 414 from a storage medium 420. The storage medium 420 may be co-located with the system 400 as shown, or it can be remote and communicatively coupled to the computer system 400. Such communications may be encrypted.

The computer system 400 may be a stand-alone programmable system, or a programmable module included in a larger system. For example, the computer system 400 can be included as part of a larger data processing architecture. Also, the computer system 400 may include one or more hardware and/or software components configured to fetch, decode, execute, store, analyze, distribute, evaluate, and/or categorize information.

The processor 414 may include one or more processing devices or cores (not shown). In some embodiments, the processor 414 may be a plurality of processors, each having either one or more cores. The processor 414 can execute instructions fetched from the memory 402, i.e., from one of memory modules 404, 406, 408, or 410. Alternatively, the instructions can be fetched from the storage medium 420, or from a remote device connected to the system 400 via a communication interface 416. An input/output (I/O) module 412 may be configured for additional communications to or from remote systems or to a user interface 403 from which the processor 414 may receive a set of requirements. Such additional communications may be facilitated by a communications interface 416.

Without loss of generality, the storage medium 420 and/or the memory 402 can include a volatile or non-volatile, magnetic, semiconductor, tape, optical, removable, non-removable, read-only, random-access, or any type of non-transitory computer-readable computer medium. The storage medium 420 and/or the memory 402 may include programs and/or other information usable by processor 414, such as for example, instructions that enable the processor 414 to data transformation and pipeline creation functions. Furthermore, the storage medium 420 can be configured to log data processed, recorded, or collected during the operation of the computer system 400.

The data may be time-stamped, location-stamped, cataloged, indexed, encrypted, and/or organized in a variety of ways consistent with data storage practice. By way of example, the memory modules 404 to 410 can form instructions that embody the method 300.

In other words, the memory modules 404 to 410 may form data transformation and pipeline creation routine 422 that can cause the processor 414 to perform certain operations upon execution. For example, the operations can include providing a repository including metadata associated with a data pipeline. The operations can further include providing a transformation logic engine configured to apply a transformation rule to a dataset of the data pipeline based on the metadata. The operations can further include providing a GUI configured to enable a user to manage an approval process based on a transformation logic of the transformation logic engine. Moreover, the operations can further include providing an automated deployment engine configured to deploy the data pipeline in a cloud environment 401.

By way of example, the memory module 404 can form the previously described Datalake/Datastorage module 114 depicted in FIG. 1 and the memory module 406 can form the previously described job orchestration service module 116 in FIG. 1. By way of example, the instructions embodied in these memory modules can cause the processor 414 to perform certain operations consistent with the functions described in FIG. 1. Alternatively, the instructions may cause the processor 414 above or alternatively to perform the method 300 of FIG. 3.

Having described above several detailed embodiments, the teachings of the present disclosure are now described according to a general system embodiment and its corresponding method embodiment. Specifically, in one exemplary embodiment, a system is provided comprising a processor and a memory storing instructions that, when executed by the processor, cause the system to perform various operations associated with the orchestration, transformation, and deployment of a data pipeline. The system includes a repository configured to store metadata associated with the data pipeline, wherein the metadata comprises information relating to source datasets, destination datasets, transformation sequences, and processing dependencies.

A transformation logic engine is configured to apply at least one transformation rule to a dataset of the data pipeline based on the metadata. The transformation logic engine may also be configured to dynamically generate pipeline execution scripts. The system further comprises a GUI configured to enable a user to manage an approval process related to the transformation logic applied by the transformation logic engine. In some embodiments, the GUI includes audit logging features to record actions and decisions within the approval workflow.

An automated deployment engine is further provided and configured to deploy the data pipeline in a cloud environment. The automated deployment engine may deploy the data pipeline following the application of the transformation rule to the dataset. In some embodiments, the system further includes a lineage tracking module configured to maintain a record of the transformation rule application.

The system may additionally include a metrics dashboard for monitoring pipeline performance, one or more machine learning modules configured to recommend transformation rules based on identified dataset patterns, and a generative AI engine configured to propose transformation workflows based on high-level user goals. The system may also comprise self-healing mechanisms for automatically correcting pipeline execution failures, and a digital twin simulation engine configured to perform virtual testing of pipeline configurations prior to production deployment.

The metadata-driven framework disclosed herein provides several advantages. One advantage includes dynamic pipeline configuration and execution. Each pipeline is configured using a declarative metadata which specifies:
a) Source and destination datasets;
b) Transformations to be applied; and
c) Processing rules and dependencies.

The framework automatically generates and executes pipelines based on this configuration, significantly reducing manual efforts.

Also provided is metadata-driven transformation logic that maintains a central repository where transformation rules are stored, as metadata. This metadata defines:
d) Pipeline attributes;
e) Transformation logic per dataset; and
f) An execution sequence.

When a pipeline is executed, the metadata repository dynamically applies the appropriate transformations without requiring manual code updates.

An additional advantage is a UI-driven management with maker-checker process. Also, the metadata-driven framework described herein features a GUI for transformation management, enabling:
a) Creation, modification, and deletion of transformation rules;
b) A maker-checker approval process to validate changes;
c) Audit logs for governance and compliance; and
d) Automated Deployment & Cloud Integration.
   Upon approval, transformations are automatically deployed into the cloud computing environment using a CI/CD pipeline. This ensures that:
a) Changes are applied in real-time without downtime;
b) Transformation logic remains consistent across all environments; and
c) Data Lineage and Auditability.

The disclosed The metadata-driven framework tracks all transformations applied to datasets, providing a clear lineage trail. This feature enhances:
a) Regulatory compliance;
b) Debugging and troubleshooting; and
c) Data integrity validation.

Additional embodiments provide additional features, such as automated data quality checks. This feature implements automated mechanisms to continuously monitor datasets for anomalies, missing values, or inconsistencies. By leveraging machine learning and rule-based systems, the toolkit identifies potential data quality issues in real-time. It provides alerts and suggests corrective actions, such as data cleaning or transformation steps, to ensure data integrity and reliability. Users can customize quality checks based on specific requirements and thresholds.

Monitoring and performance features include metrics dashboard and optimization alerts and swarm intelligence for resource optimization. With metrics dashboard and optimization alerts, a comprehensive metrics dashboard provides real-time insights into pipeline performance, including execution time, resource utilization, error rates, and throughput. The dashboard offers visualizations and trend analysis, enabling users to identify performance bottlenecks and inefficiencies. The system generates alerts and recommendations for optimization, helping users maintain optimal performance and resource usage.

Swarm intelligence algorithms, inspired by the collective behavior of natural systems, optimize resource allocation and scheduling across distributed cloud environments. The system dynamically adjusts resources based on workload demands, improving efficiency and reducing costs. This approach ensures that resources are utilized effectively, minimizing idle time and maximizing throughput.

Maintenance and reliability features are also provided. For example, self-healing mechanisms automatically detect and resolve pipeline failures or performance bottlenecks using AI-driven diagnostics. The system continuously monitors pipeline health and applies corrective actions, such as rerouting data, restarting failed components, or adjusting configurations, without human intervention. This ensures continuous operation and reliability.

Digital twins, virtual replicas of data pipelines, simulate and test transformations and configurations in a controlled environment. Users can experiment with different scenarios, identify potential issues, and optimize configurations before deploying them in production. This reduces risk and improves reliability by allowing for thorough testing and validation

A transformation management capability includes predictive transformation suggestions, generative AI for workflow design, and a transformation template library. In an embodiment, ML algorithms analyze historical data and transformation patterns to provide predictive suggestions for transformations based on dataset characteristics. The system recommends the users can accept, modify, or reject suggestions based on their specific needs.

Generative AI models automatically design and propose complex transformation workflows based on high-level user goals or dataset characteristics. This feature reduces the need for manual configuration by generating workflows that align with strategic objectives. Users can review and customize the proposed workflows as needed. A library of pre-built transformation templates is offered, allowing users to customize and apply them to their pipelines. The templates cover common transformation scenarios and best practices, streamlining the transformation process and encouraging consistency across pipelines.

Additional embodiments of the present disclosure provide enhanced security and governance. For example, an aspect of the embodiment provide role-based access controls and data encryption that enhance security and compliance. The system ensures that only authorized users have access to sensitive data and transformation logic. Data encryption protects data at rest and in transit, safeguarding against unauthorized access and breaches. Detailed audit logs and user activity tracking improve governance and accountability. The system records all user actions and changes to the system, facilitating compliance with regulatory requirements. Users can review logs to track changes, identify potential security issues, and ensure accountability.

The metadata-driven framework, as described herein, strategically enhances the pipeline development process by automating and streamlining various tasks. The automating and streamlining significantly reduces the time and effort required for pipeline development. Subsequently substantial time and cost savings can be delivered while improving the quality and scalability of business operations.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A system, comprising:
a processor;
a memory comprising instructions, which when executed, cause the processor to perform operations comprising:
providing a repository including metadata associated with a data pipeline;
providing a transformation logic engine configured to apply a transformation rule to a dataset of the data pipeline based on the metadata;
providing a graphical user interface (GUI) configured to enable a user to manage an approval process based on a transformation logic of the transformation logic engine, wherein the GUI supports a maker-checker workflow that allows a maker to create or modify transformation rules and a checker to approve the transformation rules prior to deployment;
providing an automated deployment engine configured to deploy the data pipeline in a cloud environment, wherein upon approval, transformations are automatically deployed into the cloud environment.

2. The system of claim 1, wherein the automated deployment engine is configured to deploy the data pipeline subsequent to the transformation rule having been applied to the dataset.

3. The system of claim 1, wherein the system tracks transformations applied to the dataset and maintains a record of the transformation rule having been applied to the dataset to provide a lineage trail.

4. The system of claim 1, wherein the transformation logic engine dynamically generates pipeline execution scripts.

5. The system of claim 1, wherein the metadata includes information about source datasets, destination datasets, transformation sequences, and processing dependencies.

6. The system of claim 1, wherein the GUI includes audit logging features.

7. The system of claim 1, wherein the system further includes a metrics dashboard for pipeline performance monitoring.

8. The system of claim 1, wherein machine learning algorithms recommend the transformation rules based on dataset patterns.

9. The system of claim 1, further comprising a generative AI engine configured to propose transformation workflows based on high-level user goals.

10. The system of claim 1, wherein the system includes self-healing mechanisms for automatic correction of pipeline execution failures.

11. The system of claim 1, wherein a digital twin simulation engine allows for virtual testing of pipeline configurations prior to production deployment.

12. A computer-implemented method for transforming a data pipeline, comprising:
providing a repository including metadata associated with a data pipeline;
providing a transformation logic engine configured to apply a transformation rule to a dataset of the data pipeline based on the metadata;
providing a graphical user interface (GUI) configured to enable a user to manage an approval process based on a transformation logic of the transformation logic engine, wherein the GUI supports a maker-checker workflow that allows a maker to create or modify transformation rules and a checker to approve the transformation rules prior to deployment;
providing an automated deployment engine configured to deploy the data pipeline in a cloud environment, wherein upon approval, transformations are automatically deployed into the cloud environment.

13. The method of claim 12, further comprising automatically deploying the data pipeline subsequent to the transformation rule having been applied to the dataset.

14. The method of claim 12, further comprising maintaining a record of the transformation rule having been applied to the dataset to provide a lineage trail.

15. The method of claim 12, further comprising dynamically generating pipeline execution scripts.

16. The method of claim 12, further comprising monitoring a performance of the pipeline via a dashboard.

17. The method of claim 12, further comprising maintaining version control of changes to the transformation logic.

18. The method of claim 12, further comprising deploying the data pipeline to the cloud environment utilizing a continuous delivery platform.

19. The method of claim 12, further comprising deploying the data pipeline to the cloud environment utilizing a continuous integration and continuous delivery/deployment (CI/CD) pipeline.

20. A non-transitory computer readable medium having stored thereon computer executable instructions that, if executed by a processor, cause the processor to perform a method comprising:
providing a repository including metadata associated with a data pipeline;
providing a transformation logic engine configured to apply a transformation rule to a dataset of the data pipeline based on the metadata;
providing a graphical user interface (GUI) configured to enable a user to manage an approval process based on a transformation logic of the transformation logic engine, wherein the GUI supports a maker-checker workflow that allows a maker to create or modify transformation rules and a checker to approve the transformation rules prior to deployment;
providing an automated deployment engine configured to deploy the data pipeline in a cloud environment, wherein upon approval, transformations are automatically deployed into the cloud environment.
